(19) United States
(12) Patent Application Publication
(10) Pub. No.: US 2001/0017286 A1
(43) Pub. Date: Aug. 30, 2001

(54) Low rate removal etch process in the manufacture of semiconductor integrated devices using a dielectric film deposition chamber

(76) Inventor: Luca Zanotti, Agrate Brianza (IT)

Correspondence Address: Lisa K. Jorgenson, STMICROELECTRONICS, Inc., 1310 Electronics Drive, CARROLLTON, TX, 75006-5039, US

(21) Appl. No.: 09/759,125

(22) Filed: Jan. 11, 2001

(30) Foreign Application Priority Data
Jan. 20, 2000 (IT) MI2000A 000065

(51) Int. Cl. H01B 13/00; C23F 1/00

(52) U.S. Cl. 216/13; 216/67; 216/71; 216/79

(57) ABSTRACT

The present invention relates an etch process of a dielectric film deposited on a substrate, characterized by using a chamber of PECVD type having an upper electrode coupled with a RF source and a lower electrode connected to ground on which a silicon substrate is placed. The etch of the dielectric film is obtained by means of a plurality of active gases mixed with at least one conveyance gas so as to obtain a low rate of etch and an uniform etch of said deposited dielectric film.

### FIELD OF THE INVENTION

The present invention relates to an etch process of the type with low rate of removal in the manufacture of semiconductor integrated devices.

### BACKGROUND OF THE INVENTION

In the field of semiconductor integrated devices after a first operation of deposition of dielectric films on a silicon substrate, by means of a chamber adapted for the deposition of said films, for example PECVD (Plasma Enhanced Chemical Vapor Deposition), APCVD (Atmospheric Pressure CVD), LPCVD (Low Pressure CVD), HDPCVD (High Density PCVD), there is a second etch operation at said dielectric films made by another chamber called RIE and/or MERIE (Reactive Ion Etch; Magnetically Enhanced RIE).

The etch operation refers to a selective removal of undesired material from the substrate surface and it is obtained by masks and photoresist.

There are two types of etch: 1) wet etch, usually identified as chemical etch, using liquid chemical agents for the etch of the substrate surface; and 2) dry etch, usually identified as ionic etch, using plasma, ionic beams and sputter etch for the etch of the substrate surface.

For the etch operation of thin dielectric films, having a thickness of some tenth of angstroms, such as gate oxide, thermal oxide, tunnel or interpoly oxide, oxides obtained by a reoxidation process, antireflecting dielectrics, classically the wet etch technology is used. Such a process foresees the use of hydrofluoric acid (HF) for silicon oxides or phosphoric acid (H₂PO₄) for silicon oxynitride and nitride because it is possible to obtain a controlled and repeatable process. That is, it is possible to have an etch with a low rate of removal of dielectric films, called etch rate, and to repeat said operation in the time with the same effectiveness.

Typical values of etch rate in case HF acid is used are about 5 angstroms per minute for the etch of the thermal oxide, while in the case H₂PO₄ acid is used for the etch of the silicon oxynitride typical values are about 100 angstroms per minute.

We deduce, therefore, that an advantage of the wet etch is in the precision of the thickness of the removed dielectric.

The principal disadvantage of the wet etch is that the effectiveness of the acid solution is variable in function of how many etches the solution has made, of the value of the dust quantity (checking of the particles present in the solution) and of the contamination value of the oxide layer (for example contamination of phosphor atoms in the case of a solution based on H₂PO₄ acid).

The traditional apparatuses of etch to the oxide layers, called RIE (Reactive Ion Etch) or MERIE (Magnetically Enhanced RIE), use the ionic etch technology. These apparatuses necessitate the excitement of a gas compound by means of an electric field produced by an RF source, that is a radio—frequency source, so that a plasma envelope is produced, adapted to produce ions. These ions collide with the silicon substrate, causing a removal of a determined thickness of the dielectric film.

Typical values which said chambers can reach as etch rate are about 500 angstroms per minute.

The principal disadvantage of said apparatuses is that it isn't possible to have an acceptable etch uniformity since they show values greater than 8% at 1 σ (σ is standard deviation).

We are in a situation in which the lowest etch rate values, and therefore the best precision, are obtained by an etch of wet type while the technology provides chambers for the etch of dielectric films having an etch of dry type (ionic etch).

In view of the state of the art described, it is an object of the present invention to provide a process to obtain a low rate of etch, typical of wet etches, and to maintain the advantages of the etches of ionic type with respect to the wet etches.

### SUMMARY OF THE INVENTION

According to the present invention, such object is achieved by an etch process of a dielectric film deposited on a substrate, characterized by using a chamber of PECVD type, comprising an upper electrode coupled with a RF source and a lower electrode connected to ground on which a silicon substrate is placed, wherein the etch of the dielectric film is obtained by means of a plurality of active gases mixed with at least one conveyance gas so as to obtain a low rate of etch and an uniform etch of said deposited dielectric film.

Thanks to the present invention a process is provided by means of which is possible to make a dry etch at a low rate in the manufacture of semiconductor integrated devices by using a classic chamber of PECVD type, designed for the deposition of dielectric films, instead of a chamber of RIE or MERIE type, designed for the etch of dielectric films.

This process has the advantage of using only one apparatus, the chamber PECVD, adapted to develop the functions of deposition of dielectric films and moreover adapted to make the etch to said dielectric films with remarkable saving of money and time.

Furthermore the present invention has also the advantage to obtain a repeatable etch thanks that the PECVD chamber has been designed to execute repeatable and uniform depositions of the dielectric films.

The features and the advantages of the present invention will be made evident by the following detailed description of an embodiment thereof which is illustrated as not limiting example in the annexed drawings, wherein:

### BRIEF DESCRIPTION OF THE DRAWINGS

FIG. 1 shows a configuration of a chamber of RIE or MERIE type.

FIG. 2 shows a configuration of a chamber of PECVD type.

### DETAILED DESCRIPTION

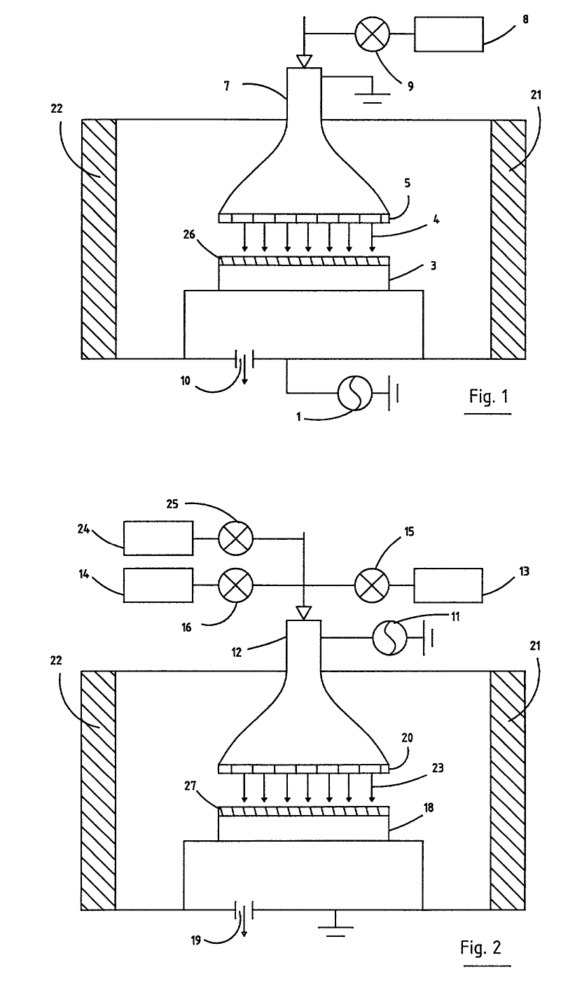

In FIG. 1 a configuration of a chamber of RIE or MERIE type is shown. As shown in such a Figure a RF source 1 is connected with an electrode 2, called cathode, on which a silicon substrate 3 is placed, on which a dielectric film 26, for example, of Si₃N₄ (or SiO₂, SiOₓN_{y}, PSG, BPSG, FSG, SiC, etc.), has previously been deposited by a chamber, for example PECVD (or chambers of APCVD, LPCVD, HDPCVD type), and a second electrode 7, called anode, connected to ground. On the base of the cathode 2 a hole 10 for the outgoing of exhaust gas (pointed out by an arrow) is foreseen also.

Moreover a tank 8, containing active gas, that is connected to the anode 7, is provided of a diffusion grid 5, by a valve 9 adapted to regulate the flow of said active gas.

The voltage difference between cathode and anode is so as to generate a plasma envelope 4 (pointed out with a plurality of arrows), due to the admission and to the excitement of said active gas in the chamber by means of said grid 5.

The dielectric film 26, for example Si₃N₄, previously deposited on the substrate 3 by means of a chamber of PECVD type, according to the prior art, therefore, is hit by said plasma flow 4. In this way the dielectric film Si₃N₄ 26 is undergone to an ionic bombardment, thanks to which it is possible to make the etch.

The electrodes of cathode 2 and anode 7 with the grid 5 are contained in a chamber (RIE or MERIE) having walls 21 and 22 of insulating material, preferably made by aluminum oxide Al₂O₃.

The reacting gases, therefore, flow through the grid 5 in the chamber wherein they are mixed. The commonly used gases have as common element the fluorine (F) among which there are gases as: NF₃, CF₄ and SF₆.

In chambers of heretofore described type, these gases allow to obtain etch values according to the following table:

PIE and/or MERIE standard chamber

| | |
|---|---|
| Typical etch rate [nm/min] | Greater than 100 |
| Minimum etch rate [nm/min] | 50 |
| Non uniformity | Greater than 8% at 1 σ |

In FIG. 2 a configuration of a chamber of PECVD type is shown. In such a Figure a RF source 11 is connected to an electrode 12, called anode, at which a plurality of tanks 13, 14 and 24 with respective regulation valves 15, 16 and 25 are connected. The tank 13 contains the active gas, while the tank 14 contains the conveyance gas and the tank 24 contains the gas adapted for the deposition of the dielectric film 27. Moreover the cathode electrode 12 is connected to a diffusion grid 20.

A silicon substrate 18 on a lower electrode 17, called anode, having a discharge valve 19 for exhaust gas, is placed. The anode electrode 17 is connected to ground.

The electrodes of anode 17 and cathode 12 with respective grid 20 are contained in an insulating chamber (PECVD) having walls 21 and 22 of insulating material, preferably made by aluminum oxide Al₂O₃.

These chambers alternate a first deposition step of said dielectric film 27 on said silicon substrate 18, step for which the PECVD chambers are designed, a second removal step from the chamber of the substrate 18 by means of a mechanic arm (not shown in Figure), a third cleaning step to remove the dielectric film 27 that deposits on the walls 21 and 22 during the deposition operation of said dielectric film 27 by the use of a compound of freon plus oxygen, as hereinafter shown, and a fourth step of admission of a second substrate 18 in the chamber and a new deposition of dielectric film 27 on said substrate 18.

The periodicity of execution of said third step can be every two or three substrates 18.

The Applicant has found that the used chemistry (active gas contained in the tank 13) during said third phase, that is during the cleaning step of the walls 21 and 22 of the chamber, opportunely mixed with conveyance gas (contained in the tank 14) and undergone to predetermined working conditions, such as power of the plasma 23, working pressure and distance between the electrodes 12 and 17, allows to realize the etch to the dielectric film with different working points, with different etch rates and etch uniformity.

Particularly the operation of dry etch is an etch of blanket type, for example an etch to define the spacers, on the whole substrate 18.

The active gases, contained in the tank 13 and regulated by the valve 15, are gases that have as common element the fluor (F) among which there are gases as: NF₃, C₂F₆, CF₄, SF₆, C₃F₈ and PFC₅.

The conveyance gases, also called inert gases, contained in the tank 14 and regulated by the valve 16, are inert gases and preferably we use nitrogen (N₂), helium (He) or argon (Ar).

The deposition gases, contained in said tank 24 and regulated by said valve 25, are deposition reactant gases that must give origin to silicon oxide and preferably they are SiH₄ and N₂O or TEOS and O₂.

The voltage difference between the cathode and anode is so as to generate a plasma envelope 23 (pointed out with a plurality of arrows), due to the admission and the excitement of said gas in the chamber by means of said grid 20.

The dielectric film 27, for example Si₃N₄, previously deposited on the substrate 3 by means of a said PECVD chamber, therefore, is hit by said plasma flow 23 through said grid 20 connected to said anode 12. In this way, in a first step of feeding of deposition gas the dielectric film Si₃N₄ 27 is deposited on said silicon substrate 18, and after the feeding of active gas and conveyance gas provides to the cleaning of the walls 21 and 22 of the PECVD chamber and to the etch of the dielectric film 27.

In the chambers, heretofore described, etch values according to the following table are obtained:

PECVD chamber with inert gas

| | |
|---|---|
| Typical etch rate [nm/min] | Lower than 30 |
| Minimum etch rate [nm/min] | 6 |
| Non uniformity | Lower that 6% at 1 σ |

Comparing the scheduled values for PECVD chambers and RIE and/or MERIE chambers with the first type a lower etch rate is obtained so as to remove dielectric films having thickness of few angstroms, that is a higher uniformity, and an etch process more repeatable is obtained in the time.

The use of a PECVD chamber to execute the etch of the dielectric films, moreover, allows a better regulation of the distance between the electrodes 12 and 17 and this makes easier a process optimization, particularly for the etch uniformity.

To perform the etch to these dielectric films, as heretofore described, active gas adapted for the cleaning “in situ” of the walls 21 and 22 of the PECVD chamber and also of the electrode chucks 12 of the electrodes 12 and 17 must be combined with mixing and conveyance gas.

It is obtained for example a situation in which said active gas and said conveyance gas are combined, as for example:

CF₄+N₂O in He, Ar, N₂

C₂F₆+O₂ in He, Ar, N₂

C₂F₆+NF₃+O₂ in He, Ar, N₂

The conveyance gas must be inert gas and it is preferred a gas as helium (He) thanks also to its higher thermal conductivity wherein the flow is in a range between 500-4000 sccm (standard cubic centimeters per minutes). Moreover the plasma power can be changed in a range between 200-1000 W, the pressure from 1 to 10 Torr and the distance between the electrodes 12 and 17 from 200 to 500 mils by changing opportunely the value of the source RF 11. With these values it is possible to obtain different working points giving origin to values of etch rate between 60 angstroms per minute and 450 angstroms per minute, with an etch uniformity lower than 6% at 1 σ.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A process of etching a dielectric film deposited on a substrate comprising the acts of:
placing a silicon substrate having a dielectric film deposited thereupon in a plasma enhanced chemical vapor deposition PECVD chamber having an upper electrode coupled with a RF source and a lower electrode connected to ground, where the silicon substrate is placed on the lower electrode; and
etching the deposited dielectric film in said PECVD chamber with a plurality of active gases mixed with at least one conveyance gas.

2. The etching process according to the claim 1 wherein the at least one conveyance gas is a chemically inert gas.

3. The etching process according to the claim 1 wherein in said etching step is performed in a range of pressure between 1 and 10 Torr.

4. The etching process according to the claim 1 wherein in said etching step is performed with a distance range of the electrodes between 200 and 500 mils.

5. The etching process according to the claim 1 wherein in said etching step is performed with said upper electrode coupled to a RF source in a range of power between 200 and 1000 W.

6. The etching process according to the claim 2 wherein in said conveyance gas is helium (He).

7. The etching process according to the claim 6 wherein in said etching step is performed with a helium (He) flow in a range between 500-4000 sccm.

8. The etching process according to the claim 2 wherein in said conveyance gas is argon (Ar).

9. The etching process according to the claim 2 wherein in said conveyance gas is nitrogen (N₂).

10. The etching process according to the claim 3 wherein one of said active gases is NF₃.

11. The etching process according to the claim 3 wherein one of said active gases is CF₄.

12. The etching process according to the claim 3 wherein one of said active gases is SF₆.

13. The etching process according to the claim 3 wherein one of said active gases is C₂F₆.

14. The etching process according to the claim 3 wherein one of said active gases is C₃F₈.

15. The etching process according to the claim 3 wherein one of said active gases is PFC₅.

16. A process of etching a dielectric film deposited on a substrate comprising the acts of:
placing a silicon substrate in a plasma enhanced chemical vapor deposition PECVD chamber having an upper electrode coupled with a RF source and a lower electrode connected to ground, where the silicon substrate is placed on the lower electrode;
depositing of a dielectric film on the silicon substrate in the PECVD chamber;
combining a plurality of active gases with at least one conveyance gas in said PECVD chamber; and
etching said dielectric film in said PECVD chamber with said combined gases.
